(19) United States
(12) Patent Application Publication
(10) Pub. No.: US 2016/0269420 A1
(43) Pub. Date: Sep. 15, 2016

(54) APPARATUS FOR VERIFYING SAFETY OF RESOURCE, SERVER THEREOF, AND METHOD THEREOF

(71) Applicant: Electronics and Telecommunications Research Institute, Daejeon-si (KR)

(72) Inventor: Cin Young HUR, Daejeon-si (KR)

(21) Appl. No.: 15/066,508

(22) Filed: Mar. 10, 2016

(30) Foreign Application Priority Data
Mar. 10, 2015 (KR) 10-2015-0033298

(51) Int. Cl. H04L 29/06

(52) U.S. Cl. CPC H04L 63/123; H04L 63/10

(57) ABSTRACT

According to an exemplary embodiment, an apparatus for verifying safety of a resource may include: a resource requester to request a resource to an origin server, whose origin is trustworthy; validation information storage to acquire the resource from the origin server, and store a unique identifier and a signature about a web resource of a cross-domain, which the resource refers to; a validation verifier to compare the unique identifier included in validation information and a unique identifier, which is received from the third party server that includes the cross domain, so as to check the authenticity of the web resource of the cross-domain; and a granter to check the authenticity thereof, determine whether the web resource is a web resource, whose safety is verified by the origin server, and grant an access to the web resource of the cross-domain.

### CROSS-REFERENCE TO RELATED APPLICATION(S)

This application claims the benefit under 35 U.S.C. §119(a) of Korean Patent Application No. 10-2015-0033298, filed on Mar. 10, 2015, in the Korean Intellectual Property Office, the entire disclosure of which is incorporated herein by reference for all purposes.

### BACKGROUND

1. Field

The following description relates to a technology related to web security, which verifies safety of a web resource and approves an access to the web resource.

2. Description of the Related Art

As web technology is used as a common platform in various information communications devices, such as PC, mobile, and a device using an embedded system, a web browser is installed in various devices. A web security policy used in general is the Same-Origin Policy, where a domain first accessed by a user agent is assumed as an original origin, and an access to a web resource of another domain (cross-domain), which is not validated, other than the original origin is blocked.

The same-origin policy is useful in filtering the origin of a resource of a particular type on the side of a user agent, but which may be construed as making the range of the origin narrow, where its distinction criteria is limited. Also, the same-origin policy may have a limit in fusing a large amount of web resources, having their various origins, in an information communications device using a web platform.

### SUMMARY

The following description relates to a technology, in which an origin server and a user agent can verify safety of a web resource of a cross-domain.

In one general aspect, an apparatus for verifying safety a resource includes: a resource requester to request a resource to an origin server, whose origin is trustworthy; validation information storage to acquire the resource from the origin server, and store a unique identifier and a signature about a web resource of a cross-domain, which the resource refers to; a validation verifier to compare the unique identifier included in validation information and a unique identifier, which is in response to a request to a third party server including the cross-domain, received from the third party server, so as to check whether the web resource of the cross-domain is an authentic web resource, whose safety is verified by the origin server; and a granter to check the authenticity thereof, determine whether the web resource is a web resource, whose safety is verified by the origin server, and grant an access to the web resource of the cross-domain.

In another general aspect, a server includes: a web resource information acquirer to with respect to a web resource of a cross-domain, which a resource of the server refers to, and whose safety is guaranteed by the server, acquire a unique identifier of the web resource of the cross domain from a third party server including the cross domain; a signature generator to generate a signature for each web resource so as to verify whether the web resource of the cross-domain is altered; and a communicator to in response to a request for the resource, provide a unique identifier and the generated signature about the requested resource and the web resource of the cross-domain, which the requested resource refers to.

In another general aspect, a method of verifying safety of a resource includes: acquiring a unique identifier of a web resource of a cross-domain from a third party server that comprises the cross-domain, with respect to the web resource of a cross domain, which a resource of a server refers to, and whose safety is guaranteed by the server; requesting a resource to the server, whose origin is trustworthy; generating a signature for each web resource so as to verify whether the web resource of the cross-domain is altered; acquiring the resource from the server, and storing, as validation information, a unique identifier and a signature about the web resource of the cross-domain, which the resource refers to; comparing the unique identifier included in the validation information and a unique identifier, which is in response to a request to the third party server including the cross-domain, received from the third party server, and checking whether the web resource of the cross-domain is an authentic web resource, whose safety is verified by the server; and checking the authenticity thereof, determining whether the web resource is a web resource, is whose safety is verified by the origin server, and granting an access to the web resource of the cross-domain.

Other features and aspects may be apparent from the following detailed description, the drawings, and the claims.

### BRIEF DESCRIPTION OF THE DRAWINGS

FIG. 1 is a diagram illustrating a communication structure between a user agent, an origin server, and a third party server according to an exemplary embodiment.

FIG. 2 is a diagram illustrating an apparatus for verifying safety of a resource according to an exemplary embodiment.

FIG. 3 is a diagram illustrating a structure of a resource according to an exemplary embodiment.

FIG. 4 is a diagram illustrating a server according to an exemplary embodiment.

FIG. 5 is a diagram illustrating an example of identifying and accessing a domain according to each name of a web source.

FIG. 6 is a diagram illustrating an example of using a web resource without the limit of the same-origin policy.

FIG. 7 is a diagram illustrating an example of granting an individual unit of a web resource to apply a detailed security polity.

FIG. 8 is a diagram illustrating an example of a method of verifying safety of a resource, which is performed between a user agent, an origin server, and a third party server.

FIG. 9 is a flowchart illustrating a method of verifying safety at a user agent according to is an exemplary embodiment.

FIG. 10 is a flowchart illustrating a method of verifying safety of a resource by using a server according to another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, an apparatus for verifying safety of a resource, a server thereof, and a method thereof according to an exemplary embodiment will be specifically described below with reference to figures.

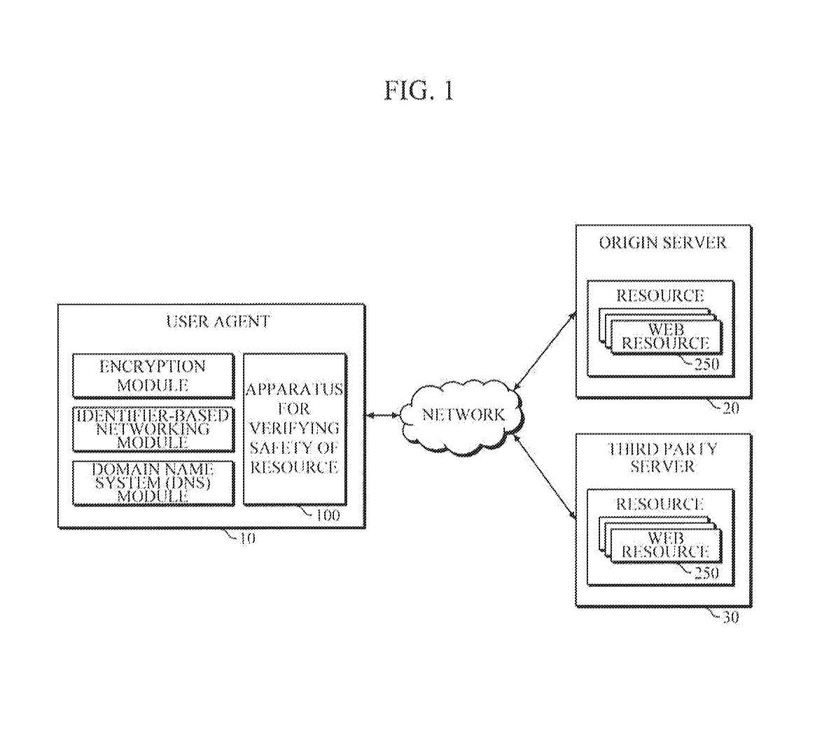

FIG. 1 is a diagram illustrating a communication structure between a user agent, an origin server, and a third party server according to an exemplary embodiment.

A user agent 10 is a program or a device that may access, analyze, and execute a resource. For example, the user agent may be a web browser or a user terminal that is used in various information communications devices. As a web technology is used as a common platform in is various information communications devices, such as a PC, a mobile, and a device using an embedded system, a web browser may provide an enriched user environment that comes close to an operating system by using HTML5, JavaScript, CSS3, etc.

The resource is data, such as a web document, JavaScript, a style sheet, an image, etc., which a user agent 10 may use, and also may include a connection link to a web resource 250 that is included in a domain of another server. Since the resource may include various forms of data, as well as the above-mentioned example, the resource is not limited to the above-mentioned example.

A server, whose origin is trustworthy when a user agent 10 accesses, is called ‘origin server 20’. In a case where a resource of the origin server includes a resource existing within a cross-domain other than a domain of the origin server, the server including the cross-domain may be called ‘a third party server 30’. The origin server and the third party server may provide a web resource to a user agent 10.

Referring to FIG. 1, the user agent 10 may include an encryption module, an identifier-based networking module, a domain name system (DNS) module, and an apparatus 100 for verifying safety of a resource. Beyond this, the user agent 10 may include a processor, a CPU that processes a web resource, and storage that stores a web resource and other information, but all of which are not illustrated in FIG. 1.

The user agent 10 may request a resource of an origin server 20 over a network, and a resource of the origin server 20 may include web resources 250 that are connected to a resource of a third party server 30.

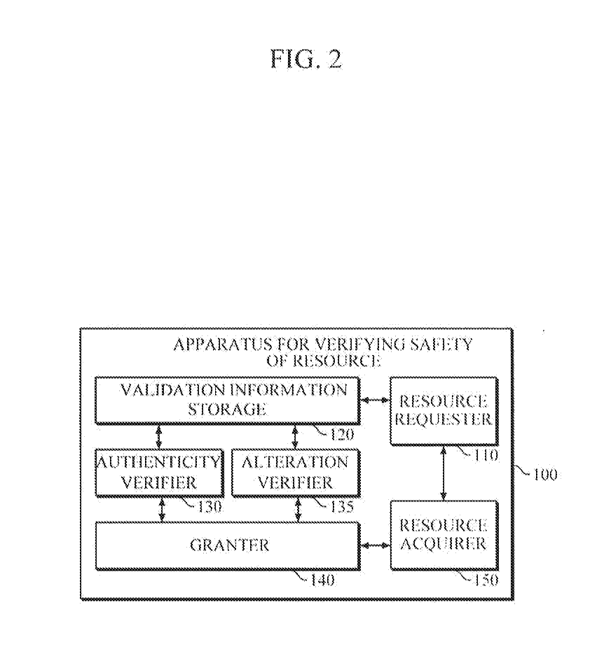

A detailed composition of the apparatus 100 may be described later with reference to FIG. 2.

FIG. 2 is a diagram illustrating an apparatus for verifying safety of a resource according to an exemplary embodiment. An apparatus 100 for verifying safety may include a resource requester 110, validation information storage 120, a validation verifier 130, an alteration verifier 135, a granter 140, and a resource acquirer 150.

The resource requester 110 requests a resource to an origin server, whose origin is trustworthy. Here, the resource of the origin server may be data, such as a web document, JavaScript, a style sheet, an image, etc., and also may include web resources connected to various domains. In addition, the resource of the origin server may include a web platform of calling a web resource of a third party server at the origin server.

The validation information storage 120 may acquire a resource from the origin server, and store a unique identifier and a signature about a web resource of a cross-domain, which a resource refers to, as validation information. The resource of the origin server may refer to the web resource of the cross-domain. Along with the resource of the origin server, the validation information storage 120 may acquire the unique identifier about the web resource of the cross-domain from the origin server, whose origin is trustworthy, and also acquire the signature that is generated for the prevention of alterations at the origin server. Thus, that the validation information storage 120 can store validation information according to each web resource. The unique identifier and signature of the validation information may be used to verify the validation of the web resource of the cross-domain, and whether the web resource is altered.

Generally, since a resource of another origin (cross-domain) may include a malicious code, an access to a resource, whose origin is not identified, may be fundamentally blocked.

However, in a case where the same-origin policy is used for web security, a standard for determining whether the resource comes from the same origin may be a simple comparison of a scheme, a domain name, and a port therebetween, thereby making difficulties in accessing various web resources. Such a case may make a problem for an identifier, e.g., a mobile terminal, a smart TV, a smart watch, and a navigation, to access each information communications device on a web platform. According to an exemplary embodiment of the present disclosure, if a user agent verifies safety according to each web resource, and more specifically, verifies a safety of a web resource within another domain through an origin server, whose origin is trustworthy, this type of the information communications device is useful in downloading a resource therein by using a web platform, or in providing a service of a mash-up type between web resources having various origins.

According to another exemplary embodiment, the validation information storage 120 may form a structure of a trust chain with respect to web resources that are connected to a plurality of domains included in the resource of the origin server. The resource of the origin server may include: web resources within the domain of the origin server; and a plurality of web resources within a plurality of domains thereof.

By using the trust chain structure started from the origin server, the validation information storage 120 may verify: web resources of a cross-domain that the resource of the origin server refers to; web resources of another cross-domain that the resource of the origin server refers to; and web resources of said another cross-domain, which are connected to the web is resources of the cross-domain. The present disclosure according to an exemplary embodiment is useful in that the resource of the origin server refers to resources within a plurality of cross-domains, or the safety is verified with respect to a resource of another cross-domain, which is connected to the resource of the cross-domain.

With respect to a web resource of a cross-domain, the validation verifier 130 compares a unique identifier, included in validation information, to a unique identifier that is, in response to the request, received from a third party server including the cross-domain. Then, the validation verifier 130 checks whether the web resource of the cross-domain is an authentic web resource, whose safety is verified by the origin server. Here, checking the authenticity thereof may be performed by authenticating a unique identifier itself, which is included in the validation information acquired from the origin server, which is trustworthy, or by transmitting a request to the third party server to confirm whether the unique identifier included in the validation information is the same as the unique identifier received from the third party server.

If the authenticity of the unique identifier within the validation information is checked, the validation verifier 130 identifies the web resource of the cross-domain as the authentic web resource of the cross-domain, whose safety is verified by the origin server having the trustworthy origin. If the two identifiers are not the same, or only the unique identifier cannot specify the web resource of the cross-domain, the safety for the web resource of the cross-domain may be threatened. Thus, the web resource, whose safety is not verified, may not have authorization for an access, an execution, downloading, etc.

According to an exemplary embodiment, an apparatus for verifying safety of resource is may further include a reliability determiner. If the web resource of the cross-domain is, by the validation verifier 130, identified as the authentic web resource, whose safety is verified by the origin server, the reliability determiner may determine reliability of the web resource of the cross-domain according to reliability that is given to the web resource of the cross-domain by the origin server.

Also, the alteration verifier 135 may verify whether a web resource is altered by using a signature including a hash-based message authentication code (HMAC), which is included in the validation information. In a case of a web resource, which is not authenticated as the identifier itself, the alteration verifier 135 checks the signature.

The granter 140 checks the authenticity thereof, determines whether the web resource is a web resource, whose safety is verified by the origin server, and grants an access to a web resource of a cross-domain. If an access to the web resource of the cross-domain is granted, the resource acquirer 150 acquires the web resource of the cross-domain directly from a third party server or by bypassing it through the origin server.

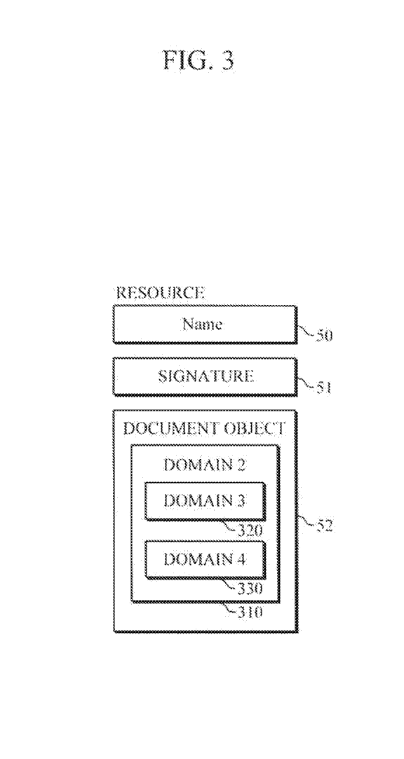

FIG. 3 is a diagram illustrating a structure of a resource according to an exemplary embodiment. But, this structure will be construed as one exemplary embodiment, and the resource may exist in various forms.

Referring to FIG. 3, a structure of a resource loaded on an apparatus for verifying safety of a resource may include a name of a web resource 50 (unique identifier), a signature 51, and a document object 52. The name of the web resource is a unique identifier, and may verify whether a web resource of a cross-domain in a third party server is altered. As illustrated in FIG. 3, the document object 52 may include web resources connected to a plurality of domains. As illustrated in FIG. 3, the document object 52 of the resource may include a web resource related to a domain 2 310 and a web resource related to a domain 3 310 and a domain 4 330, which are included in the domain 2 310. The resource may have a reference hyperlink that refers to a plurality of resources, or have a web service mash-up form.

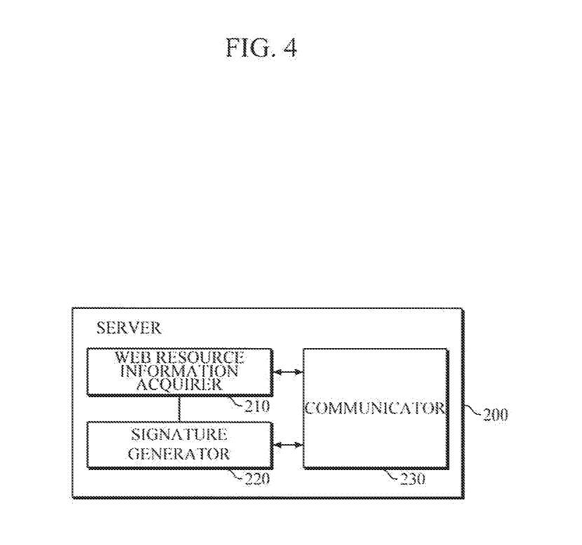

FIG. 4 is a diagram illustrating a server according to an exemplary embodiment. A server 200 may include a web resource information acquirer 210, a signature generator 220, and a communicator 230.

The web resource information acquirer 210 acquires a unique identifier and related information of the web resource from a third party server, with respect to a web resource of a cross-domain, which a resource of a server refers to, and which verifies safety in the server. The resource within the server may refer to web resources belonging to the plurality of domains, and the web resource information acquirer 210 may acquire web resource information to form a trust chain structure with respect to the web resources belonging to the plurality of the domains included in the resource. According to an exemplary embodiment, with respect to web resources of a cross-domain that a resource of a server refers to, and web resources of another cross-domain that is connected to the web resources of the cross-domain, the web resource information acquirer 210 may acquire a unique identifier according to each web resource from a third party server.

Since the web resource information acquirer 210 may further acquire other information related to a signature and a web resource, as well as the unique identifier, from the third party server, functions of the web resource information acquirer 210 will not be construed as being limited to acquiring only the information related to the unique identifier.

The signature generator 220 generates a signature according to each web resource to verify whether a web resource of a cross-domain is altered. The signature may be used for identifying and verifying the web resource, or referring to attributes, etc. According to an exemplary embodiment, the signature generator 220 may generate a signature so that a server may guarantee safety with respect to a requested resource and a web resource of a cross-domain included in the resource, and prevent the web resource from being altered. In addition, when receiving a request for the resource from an apparatus for verifying safety of a resource, the signature generator 220 may dynamically generate a signature about a requested resource and a web resource of a cross-domain.

According to another exemplary embodiment, the signature generator 220 may include an HMAC. Such a case may help the verification of whether a web resource is altered by using various authentication algorithms, e.g., HMAC-MD5 and HMAC-SHA1. Also, the signature, generated by the signature generator 220, may include the information on credibility for a web resource of a cross-domain.

In response to a request for the resource, the communicator 230 may provide a unique identifier and a signature about a resource and a web resource of a cross-domain, which is included in the resource, to the apparatus for verifying safety of the resource over a network. In addition, if there is, from the apparatus, a request for a resource, the communicator 230 may perform, by proxy, providing a web resource of a cross-domain, which the resource refers to, or providing a connection link to the web resource of the cross-domain.

There are various forms of a resource in a domain of a server, and a web resource of a cross-domain, which the resource of the server refers to. Thus, according to a type of a resource the apparatus requests, the communicator 230 may provide various types of information connected to the web resources of the cross-domain.

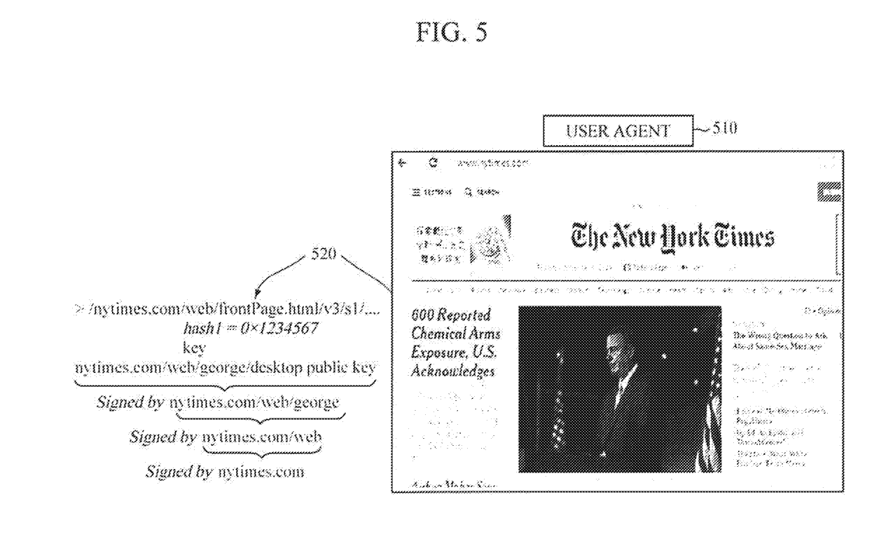

FIG. 5 is a diagram illustrating an example of identifying and accessing a domain according to each name of a web source. FIG. 5 is one example to which an exemplary embodiment is applied when a web is used in networking based on a name, such as an information centric network (ICN). A user agent 510 is a web browser, which accesses a resource “The New York Times”. A unique identifier of the New York Times is “www.nytimes.com”, and a web resource that a cross-domain of a third party server provides is included in the New York Times. Referring to FIG. 5, an article titled “600 Reported Chemical Arms Exposure, U.S. Acknowledges” belongs to a web resource 520 of a cross-domain. A unique identifier of the web resource 520 of the cross-domain is “/nytimes.com/web/fontPage.html/v3/s1/ . . . ”, and a hash thereof is “0x1234567”. An origin server that provides the resource “The New York Times” may guarantee safety with respect to the web resource 520 of the cross-domain, acquire a unique identifier of the web resource 520 of the cross-domain to verify the safety in an apparatus for verifying safety of a resource, and generate a signature according to each web resource. The apparatus may acquire validation is information from the origin server, checks safety for the article “600 Reported Chemical Arms Exposure, U.S. Acknowledges”, and grants an access. Referring to FIG. 5, the origin server may form a trust chain structure for ensuring safety of the web resource of the cross-domain, so that authenticity and safety of each article, articles having a hierarchy structure, and articles referred to in series may be guaranteed.

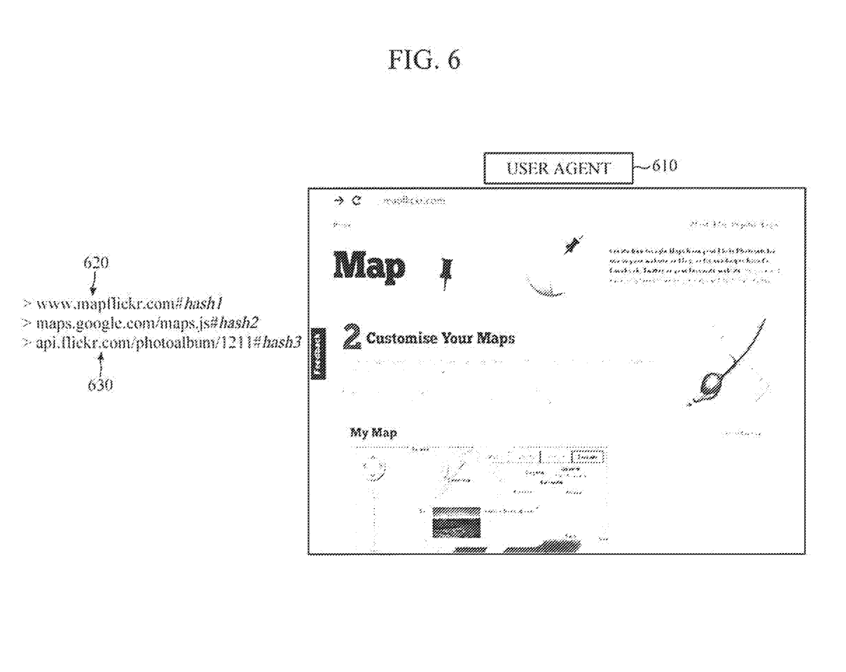

FIG. 6 is a diagram illustrating an example of using a web resource without the limit of the same-origin policy. The same-origin policy refers to a security policy, in which the side of a client using the internet trusts only a web resource of the origin server, and other than that, fundamentally blocks an access to another web resource of a cross-domain having a possibility of malice.

However, according to an exemplary embodiment, without the verification of an origin for each server, safety of a resource may be verified for each web resource, which an origin server guarantees.

Referring to FIG. 6, a user agent 610 is a web browser, and a resource of an origin server is “iMapFlickr”, which may include and provide a mash-up service using web resources of a plurality of cross-domains. Since a web resource 1 620 of a cross-domain includes a unique identifier of “www.imapflickr.com”, and accordingly, includes a signature of “#hash 1” from the origin server, safety for the web resource 1 may be verified by the origin server. In the same way, a web resource 2 630 has a unique identifier of “api.flickr.com/photoalbum/1211”, and accordingly, includes a signature of “#hash 3” from the origin server. According to an exemplary embodiment, in a case of a web resource 630 of the cross-domain being provided to a third party serve, and a mash-up service being provided using web resources of a plurality of domains, a service of a mash-up form may be provided by verifying the safety of each web resource even without using a makeshift method of bypassing the same-origin policy.

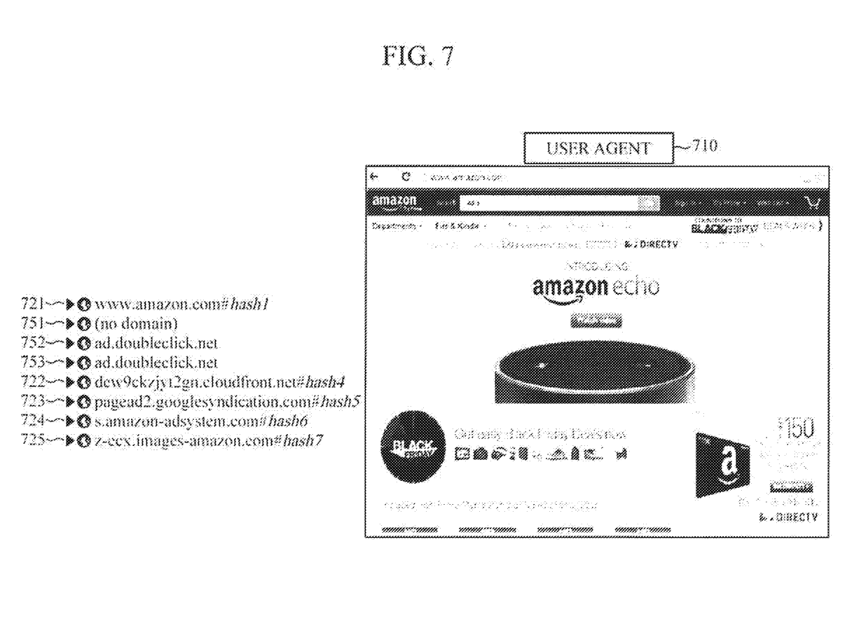

FIG. 7 is a diagram illustrating an example of granting an individual unit of a web resource to apply a detailed security polity. Referring to FIG. 7, a user agent 710 is a web browser; a resource that a domain of an origin server provides is “amazon echo”; and a unique identifier is “www.amazon.com”. In addition, a web page includes web resources of a cross-domain, which another plurality of domains provides. Here, since safety is verified for each web resource, an access to the unverified web resource may not be granted. Referring to FIG. 7, the web resources, such as “www.amazon.com #hash1” 721, “dew9kzjyt2gn.cloudfront.net #hash4” 722, “pagead2.googlesyndication.com #hash5” 723, “s.amazon-adsystem.com #hash6” 724, and “z-ecx.images-amazon.com #hash7” 725, are each granted to access a web resource of a cross-domain by an apparatus for verifying safety of a resource; and each have signatures of “#hash”. However, the web resources, such as “(no domain)” 751, “ad.doubleclick.net” 752, and “ad.doubleclick.net” 753, cannot be granted to access the web resource of the cross-domain by the apparatus. Accordingly, the side of user agent 710 does not trust the safety of web resources 751,752, and 753 of the cross-domain, whose signatures are not made by the origin server. Thus, even though there is a maliciously inserted web resource of the cross-domain when a web resource is downloaded and executed, the apparatus may use a security policy to prevent the maliciously inserted web resource from being executed.

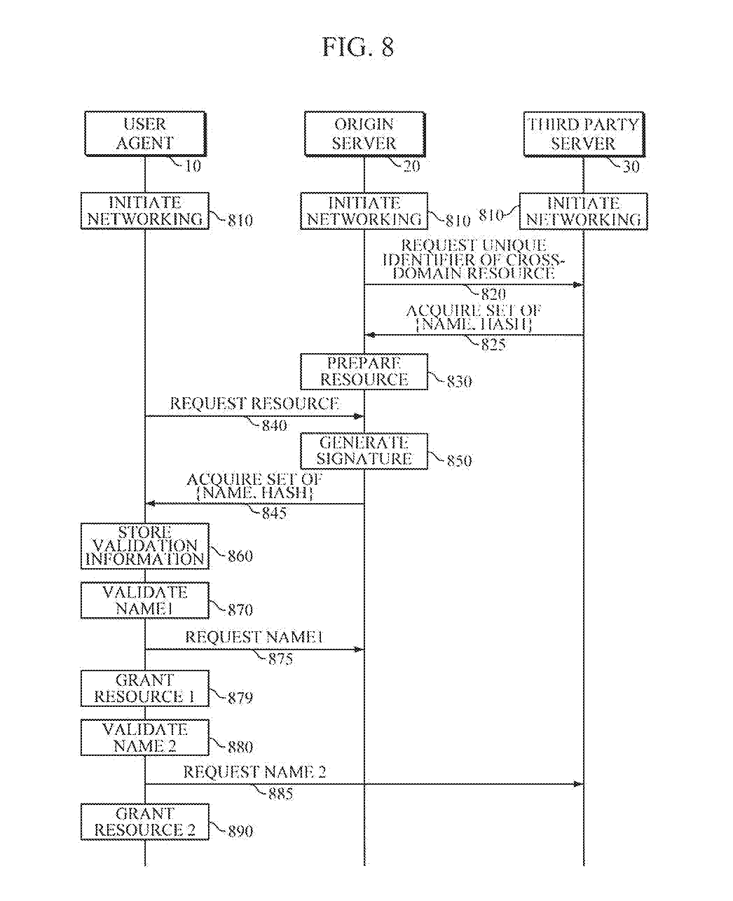

FIG. 8 is a diagram illustrating an example of a method of verifying safety of a resource, is which is performed between a user agent 10, an origin server 20, and a third party server. According to an exemplary embodiment, the user agent 10, the origin server 20, and the third party server may be connected to each other over the networking in 810.

In operation 820, the origin server 20 requests a unique identifier of a web resource to the third party server with respect to a web resource of a cross-domain, which the resource of the origin server refers to, and whose safety is guaranteed by the origin server. Then, in operation 825, the origin server 20 may acquire a set of the unique identifier (name) and the hash of the web resource of the cross-domain from the third party server that includes the cross-domain. In operation 830, the origin server 20 prepares for providing a resource along with validation information of the web resource of the cross-domain, which the resource of the origin server refers to. Here, the origin server 20 may form a trust chain structure with respect to the web resources belonging to a plurality of domains, which the resource refers to, and acquire unique identifiers of the web resources.

The user agent 10 may request a resource to the origin server 20, whose origin is trustworthy in 840.

Then, in operation 850, the origin server 20 generates a signature according to each web resource to verify whether the web resource of the cross-domain is altered. At this time, a signature of a hash (name) form may be generated, which may be used to verify whether the web resource is altered.

The user agent 10 may acquire a resource, which the user agent 10 has requested, from the origin server 20, and acquire the set of the unique identifier (name) and the hash, generated in the origin server, as validation information on the web resource of the cross-domain, which the acquired resource refers to. The user agent 10 stores the set as the validation information in 860.

Then, by using the validation information, the user agent 10 checks the authenticity of the web resource of the cross-domain, which the resource of the origin server refers to. The user agent 10 may request a unique identifier to the third party server, compare the unique identifier, which is, in response to the request, received from the third party server, to a unique identifier included in the validation information, and check whether the web resource of the cross-domain is an authentic web resource, whose safety has been verified by the server.

According to an exemplary embodiment, in a case where the user agent 10 validates the provided unique identifier 1 (Name 1) in 870, the user agent 10 requests the unique identifier 1 (name 1) to the origin server 20 in 875. If the unique identifier, which is, in response to the request, received from the origin server, is the same as a unique identifier 1 (name 1) included in the validation information, the user agent 10 confirms that such a resource is the authentic resource 1, whose safety is verified by the origin server 20. If the validation of the resource 1 is confirmed, the access to the resource 1 is granted in 890.

According to another exemplary embodiment, in a case where the user agent 10 validates a web resource 2 of the cross-domain, in 880, which the resource of the origin server refers to, the user agent 10 requests a unique identifier 2 (name 2) of the web resource of the cross-domain to the third party server 30 that includes the cross-domain in 885. If the unique identifier 2 (name 2), which is, in response to the request above, received from the third party server, is the is same as a unique identifier 2 (name 2) included in the validation information, the user agent 10 confirms that such a web resource is the authentic resource 2, whose safety is verified by the origin server 20. If the validation of the resource 2 is confirmed, the access to the resource 2 is granted in 890.

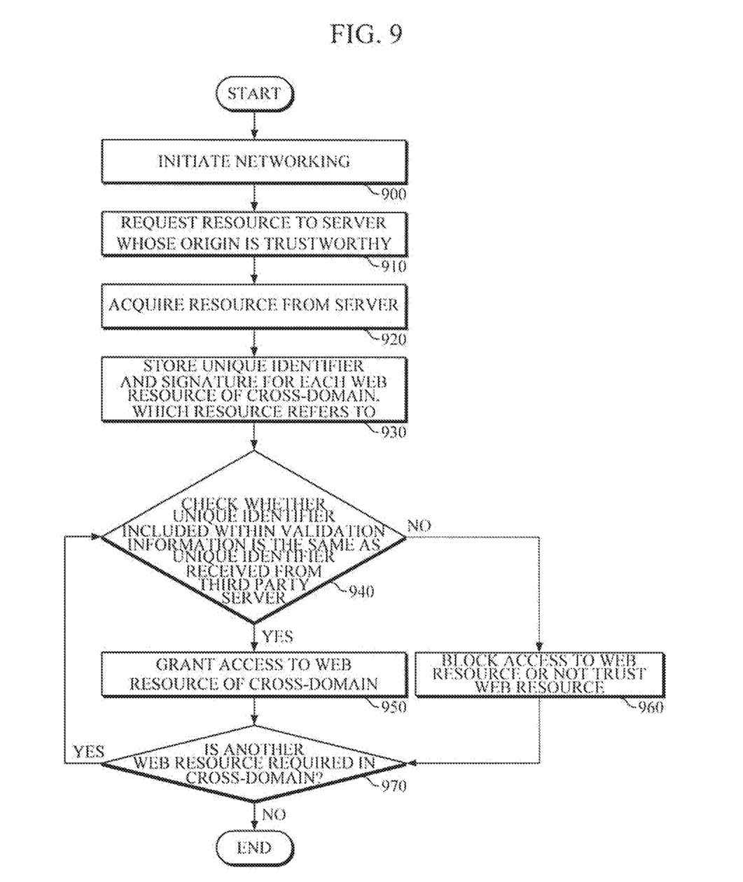

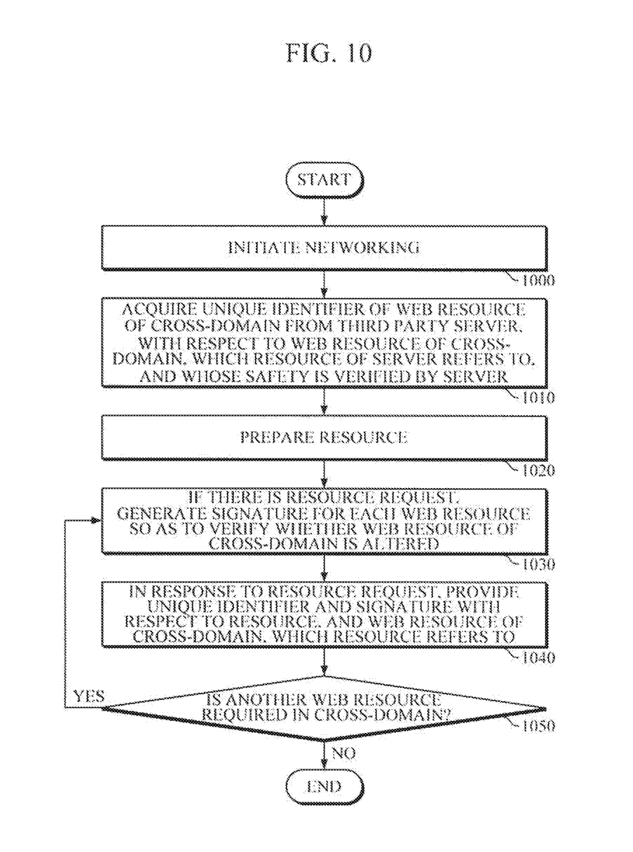

Hereinafter, methods of verifying safety of a resource, which are, respectively, performed at the user agent 10 and the server 20, will be described with reference to FIGS. 9 and 10, respectively.

FIG. 9 is a flowchart illustrating a method of verifying safety at a user agent according to an exemplary embodiment. A user agent initiates networking in 900. Then, the user agent requests a resource to a server, whose origin is trustworthy, in 910. Here, the resource may include web resources connected to a plurality of domains. The user agent acquires the resource from the server in 920, and stores, as validation information, a unique identifier and a signature for each web resource of a cross-domain, which the resource of the server refers to, in 930.

Then, the user agent authenticates the unique identifier itself, which is included in the validation information, or determines whether the unique identifier included in the validation information is the same as the unique identifier that has been received from a third party server in 940. In response to the unique identifier being determined to be the same as the unique identifier, the user agent determines it as a web resource, whose safety is verified by the server, and grants an access to the web resource of the cross-domain in 950. Here, according to reliability given to the web resource of the cross-domain by the server, reliability of the web is resource of the cross-domain may be determined. Also, the method may further include an operation of verifying whether the web resource is altered by using the signature that includes an HMAC, which is included in the validation information. Moreover, if an access to the web resource of the cross-domain is granted, the method may further include an operation of acquiring the web resource of the cross-domain from the third party server.

If the unique identifier of the validation information is not the same as the unique identifier that has been received from the third party server in 940, an access to the web resource of the cross-domain may be blocked, or the web resource may be not trusted in 960.

Then, the user agent determines whether another web resource is required in the cross-domain in 970. If the safety verification for another web resource is required, the user agent repeats operation 940 of determining whether the unique identifier included in the validation information is the same as the unique identifier received from the third party server.

If another web resource is not required in the cross-domain in 970, the process is finished. FIG. 10 is a flowchart illustrating a method of verifying safety by using a server according to another exemplary embodiment. A server initiates networking in 1000. Then, in 1010, a unique identifier is acquired from a third party server including the cross-domain, with respect to the web resource that is included in a resource of the server and that is of a cross-domain, whose safety is guaranteed by the server. Here, the server may form a structure of a trust chain with respect to web resources that are connected to a plurality of domains, which the is resource refers to. Then, the server prepares for providing the resource in 1020. If there is a request for the resource from a user agent, the server generates a signature according to each web resource, in 1030, so as to verify whether the web resource of the cross-domain is altered.

Then, in response to the request for the resource, the server provides, over a network, a unique identifier and a signature about the resource of the server and the web resource of the cross-domain, which the resource refers to, in 1040. Then, the server determines whether another web resource is required in the cross-domain in 1050. If another web resource is determined as required, the server repeats operation 1030 of generating the signature, and if not, the process is finished.

In a technology related to web security, validation and alteration checks for each web resource are performed even though domains of the web resources are not the same. Since safety for each web resource is verified by an origin server, whose origin is trustworthy, various web resources can be used in information communications devices. Also, regardless of the domain where the web resource belongs to, an access to each web resource is precisely controlled through the validation of the resource and the verification of whether the resource is altered. Using such a technology, web resources having various origins may be fused, and the use of a web platform, which is safe and expandable, may be supported.

A number of examples have been described above. Nevertheless, it should be understood that various modifications may be made. For example, suitable results may be achieved if the described techniques are performed in a different order and/or if components in a described system, architecture, device, or circuit are combined in a different manner and/or is replaced or supplemented by other components or their equivalents. Accordingly, other implementations are within the scope of the following claims.

What is claimed is:

1. An apparatus for verifying safety a resource, the apparatus comprising:
a resource requester configured to request a resource to an origin server, whose origin is trustworthy;
validation information storage configured to acquire the resource from the origin server, and store a unique identifier and a signature about a web resource of a cross-domain, which the resource refers to;
a validation verifier configured to compare the unique identifier included in validation information and a unique identifier, which is in response to a request to a third party server including the cross-domain, received from the third party server, so as to check whether the web resource of the cross-domain is an authentic web resource, whose safety is verified by the origin server; and
a granter configured to check the authenticity thereof, determine whether the web is resource is a web resource, whose safety is verified by the origin server, and grant an access to the web resource of the cross-domain.

2. The apparatus of claim 1, wherein the resource of the origin server comprises a web platform of referring to a web resource of the third party server at the origin server.

3. The apparatus of claim 1, wherein the resource of the origin server refers to web resources belonging to a plurality of domains, and the validation information storage is configured to form and store a trust chain structure with respect to the web resources of the plurality of domains, which the resource of the origin server refers to.

4. The apparatus of claim 3, wherein the validation information storage is configured to store the unique identifier and the signature according to each web resource with respect to a web resource of another domain connected to the web resources of the cross domains, which the resource of the origin server refers to.

5. The apparatus of claim 1, wherein the validation verifier is configured to determine whether the unique identifier included in the validation information is the same as the unique identifier received from the third party server.

6. The apparatus of claim 1, further comprising:
a reliability determiner configured to determine reliability of the web resource of the is cross-domain according to reliability that is given to the web resource of the cross-domain by the origin server.

7. The apparatus of claim 1, further comprising:
an alteration verifier configured to verify an alteration of the web resource by using the signature including a hash-based message authentication code (HMAC), which is included in the validation information.

8. The apparatus of claim 1, further comprising:
a resource acquirer configured to in response to an access to the web resource of the cross-domain being granted, acquire the web resource of the cross-domain from the third party server.

9. A server, comprising:
a web resource information acquirer configured to with respect to a web resource of a cross-domain, which a resource of the server refers to, and whose safety is guaranteed by the server, acquire a unique identifier of the web resource of the cross domain from a third party server including the cross domain;
a signature generator configured to generate a signature for each web resource so as to verify whether the web resource of the cross-domain is altered; and
a communicator configured to in response to a request for the resource, provide a unique is identifier and the generated signature about the requested resource and the web resource of the cross-domain, which the requested resource refers to.

10. The server of claim 9, wherein the resource refers to web resources of a plurality of domains, and the web resource information acquirer is configured to form a trust chain structure with respect to the web resource of each domain, which the resource refers to, and acquire the unique identifier about the web resource.

11. The server of claim 9, wherein the web resource information acquirer is configured to acquire a unique identifier about a web resource of another domain connected to the web resource of the cross-domain, which the resource refers to.

12. The server of claim 9, wherein the signature generator is configured to in response to a request for the resource, dynamically generate a signature about the requested resource and the web resource of the cross-domain, which the requested resource refers to.

13. The server of claim 9, wherein the signature generator is configured to generate a signature, which comprises a hash-based message authentication code (HMAC) and information on reliability about the web resource of the cross-domain.

14. The server of claim 9, wherein the communicator is configured to in response to is a request for the web resource of the cross-domain included in the resource, host the web resource of the cross-domain, or provide a connection link to the web resource of the cross-domain.

15. A method of verifying safety of a resource, the method comprising:
acquiring a unique identifier of a web resource of a cross-domain from a third party server that comprises the cross-domain, with respect to the web resource of a cross domain, which a resource of a server refers to, and whose safety is guaranteed by the server;
requesting a resource to the server, whose origin is trustworthy;
generating a signature for each web resource so as to verify whether the web resource of the cross-domain is altered;
acquiring the resource from the server, and storing, as validation information, a unique identifier and a signature about the web resource of the cross-domain, which the resource refers to;
comparing the unique identifier included in the validation information and a unique identifier, which is in response to a request to the third party server including the cross-domain, received from the third party server, and checking whether the web resource of the cross-domain is an authentic web resource, whose safety is verified by the server; and
checking the authenticity thereof, determining whether the web resource is a web resource, whose safety is verified by the origin server, and granting an access to the web resource of the cross-domain.

16. The method of claim 15, wherein the resource refers to web resources belonging to a plurality of domains; and
the acquiring of the unique identifier comprises forming a trust chain structure with respect to the web resources belonging to the plurality of domains, which the resource refers to, and acquiring the unique identifier about the web resource.

17. The method of claim 15, wherein further comprising:
in response to the authenticity being checked, determining reliability of the web resource of the cross-domain according to reliability that is given to the web resource of the cross-domain by the server.

18. The method of claim 15, further comprising:
verifying an alteration of the web resource by using the signature including a hash-based message authentication code (HMAC), which is included in the validation information.

19. The method of claim 15, further comprising:
is in response to an access to the web resource of the cross-domain being granted, acquiring the web resource of the cross-domain from the third party server.
